(19) United States
(12) Patent Application Publication
(10) Pub. No.: US 2006/0034535 A1
(43) Pub. Date: Feb. 16, 2006

(54) Method and apparatus for enhancing visibility to a machine operator

(76) Inventors: Roger D. Koch, Pekin, IL (US); Robert J. Price, Dunlap, IL (US)

Correspondence Address: CATERPILLAR INC.;100 N.E. ADAMS STREET, PATENT DEPT., PEORIA, IL, 616296490, US

(21) Appl. No.: 10/914,843

(22) Filed: Aug. 10, 2004

(51) Int. Cl. G06K 9/40; G06K 9/36

(52) U.S. Cl. 382/254; 382/284

(57) ABSTRACT

A method and apparatus for providing a view of a work area. The method and apparatus includes capturing a first image of a first desired portion of the work area, removing at least one object from the image, and providing the first image with the at least one object removed to a display.

### TECHNICAL FIELD

This invention relates generally to a method and apparatus for providing an enhanced view of a work area to an operator of a work machine and, more particularly, to a method and apparatus for providing an operator display of a work area having viewing obstructions removed from the display.

### BACKGROUND

Work machines are commonly used by operators to perform various desired work functions with substantial benefits in time and effort expended. For example, in the earthworking and construction industries, machines such as backhoe loaders are often used to dig holes and trenches. An operator of a backhoe loader can accomplish much more in much less time than is possible with manual labor.

One disadvantage with using work machines is that the ability of the operator to clearly view the work area may be diminished. The backhoe loader of the above example confines the operator to a fixed position inside a cab compartment, and the view of the work area may be partially obscured by such obstructions as the cab frame and housing, operator controls, and the work tool or portions of the work machine itself. A skilled operator eventually learns to work around these impediments. However, as more and more unskilled operators enter the workforce, problems caused by limitations on operator visibility become significant.

Other factors limit operator visibility. An operator, by virtue of being in a fixed and confined position, only has access to one view of the work area. In addition, some objects may remain invisible to an operator's view regardless of any efforts to remove obstructions caused by the machine and work tool; for example, underground objects in the dig path. An operator who knows of the existence of such underground objects can only guess at the exact location of the object relative to the work tool and must proceed with care.

The present invention is directed to overcoming one or more of the problems as set forth above.

### SUMMARY OF THE INVENTION

In one aspect of the present invention a method for providing a view of a work area is disclosed. The method includes the steps of capturing a first image of a first desired portion of the work area, removing at least one object from the image, and providing the first image with the at least one object removed to a display.

In another aspect of the present invention a method for providing a view of a work area is disclosed. The method includes the steps of capturing a plurality of images of a corresponding plurality of portions of the work area, superimposing the plurality of images such that at least one object is removed from the superimposed image, and providing the superimposed image to a display.

In another aspect of the present invention a method for providing a view of a boundary of a work area is disclosed. The method includes the steps of capturing at least one image of at least one desired portion of the work area, providing a superimposed image from the at least one image to a display, and superimposing a work boundary to the display.

In another aspect of the present invention a method for displaying an image of a work tool at a work area is disclosed. The method includes the steps of capturing at least one image of at least one desired portion of the work area, providing a superimposed image from the at least one image to a display, determining an actual position of a work tool, creating an image of the work tool, and providing the work tool image to the display at a position corresponding to the actual position.

In another aspect of the present invention a method for providing a view of a work area is disclosed. The method includes the steps of determining a location of the work area, a work machine in the work area, and a work tool attached to the work machine in site coordinates and providing a virtual image of a view of at least one of the work area, the work machine, and the work tool from at least one position other than an operator position of the work machine.

In another aspect of the present invention a method for providing a view of a work area is disclosed. The method includes the steps of capturing at least one image of at least one desired portion of the work area, providing a superimposed image from the at least one image to a display, determining a position of at least one object not visible in the work area, and superimposing an image of the object to the display.

In another aspect of the present invention an apparatus for providing a view of a work area is disclosed. The apparatus includes at least one video camera located at a desired position with respect to the work area, a controller for receiving video signals from the at least one camera, superimposing the signals, determining at least one object to remove from view, and providing a resultant video signal, and a display for receiving the resultant video signal and displaying an image of a view of the work area with the at least one object removed.

### BRIEF DESCRIPTION OF THE DRAWINGS

FIG. 1 is a block diagram illustrating an embodiment of the present invention;

FIG. 2 is a diagrammatic illustration of an embodiment of the present invention;

FIG. 3 is a further diagrammatic illustration of an embodiment of the present invention;

FIG. 4 is a further diagrammatic illustration of an embodiment of the present invention;

FIG. 5 is a further diagrammatic illustration of an embodiment of the present invention having a work boundary;

FIG. 6 is a further diagrammatic illustration of an embodiment of the present invention having a picture-in-picture;

FIG. 7 is a further diagrammatic illustration of an embodiment of the present invention having a work tool image;

FIG. 8 is a further diagrammatic illustration of an embodiment of the present invention having an alternate view;

FIG. 9 is a diagrammatic illustration of a view of an image of a work machine at a work area;

FIG. 10 is a further diagrammatic illustration of an embodiment of the present invention having a work boundary, a work tool, and an image of a not-visible object;

FIG. 11 is a diagrammatic illustration of the view of FIG. 9 and having an image of a not-visible object;

FIG. 12 is a diagrammatic illustration of another view of a work machine;

FIG. 13 is a diagrammatic illustration of yet another view of a work machine;

FIG. 14 is a diagrammatic illustration of a view of a work machine as applied to the present invention;

FIG. 15 is a diagrammatic illustration of another aspect of the present invention;

FIG. 16 is a flow diagram illustrating a method of the present invention; and

FIGS. 17a and 17b are diagrammatic illustrations of operator displays suited for use with the present invention.

### DETAILED DESCRIPTION

Referring to the drawings and the appended claims, the present invention is described with respect to a method and apparatus 100 for providing a view of a work area 102. The below described method and apparatus 100 is not meant to limit the scope of the invention, but rather is intended to be exemplary in purpose.

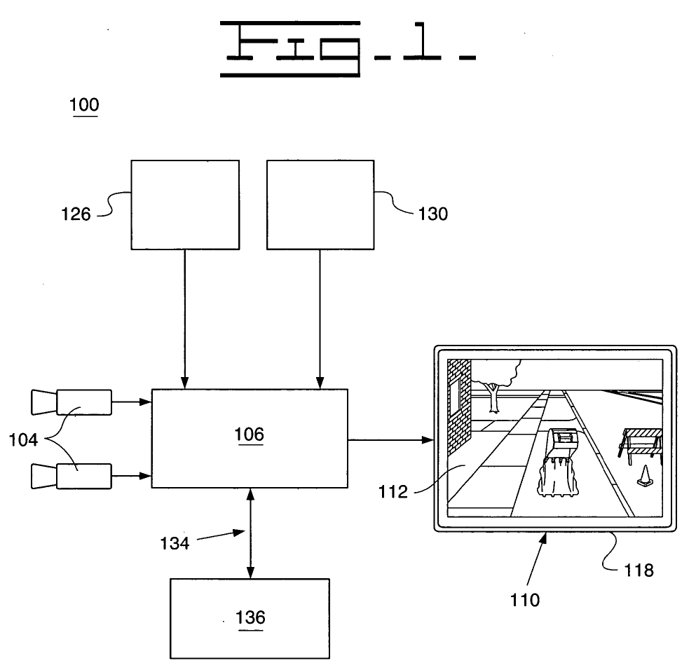

Referring specifically to FIG. 1, a block diagram illustrating an embodiment of the present invention is shown. A controller 106, typically a microprocessor-based controller, may be located on a work machine 114. The controller 106 may perform a variety of control functions on the work machine 114, as is well known in the art. Alternatively, the controller 106 may be dedicated to the purpose of the present invention as well.

At least one video camera 104 provides a video signal to the controller 106. FIG. 1 depicts two video cameras 104. However, any number of cameras may be used, for example 1, 2, 3, 4, or any other number. The video cameras 104 may be digital cameras, i.e., they may produce digital signals directly. Alternatively, the video cameras 104 may be analog cameras and the video signals may be converted to digital by some suitable means (not shown).

The video cameras 104 may be mounted on the work machine 114, may be positioned at some location other than on the work machine 114, or some combination thereof.

The controller 106 receives video signals and processes the signals, as described in more detail below. The processed video signal is then delivered to a display 110. The display 110 may be a display monitor 118, and may be located on the work machine 114. In addition or alternatively, the display monitor 118 may be located at a remote location 136 for remote monitoring and possible remote control.

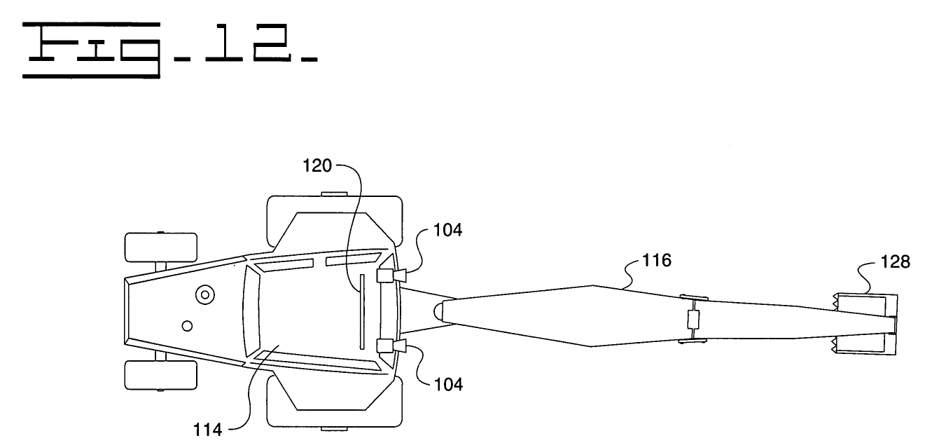

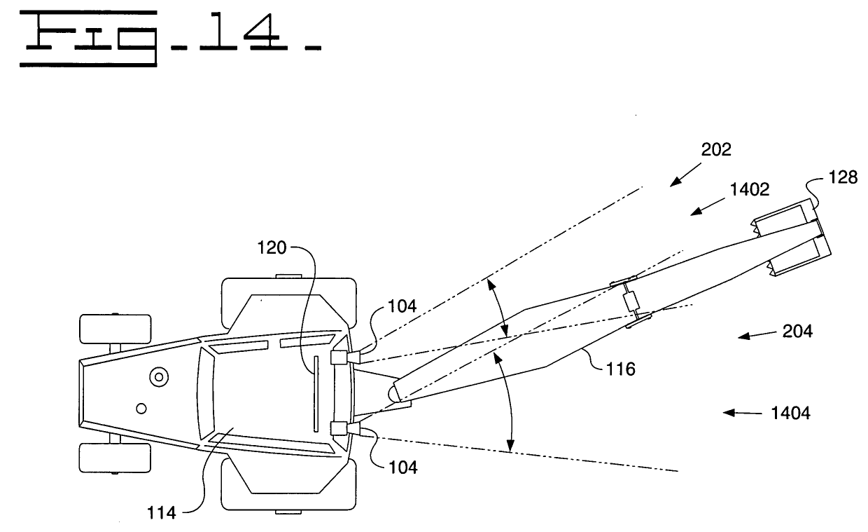

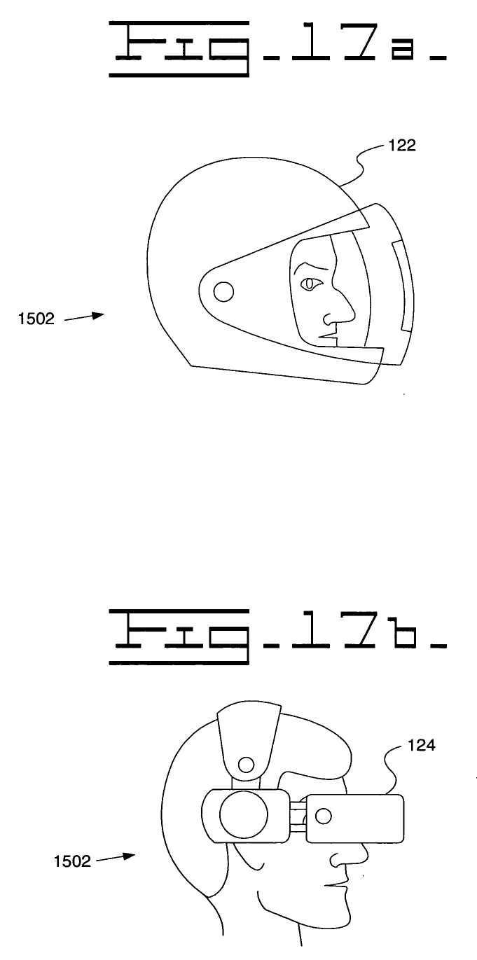

Other alternatives to a conventional display monitor 118 might include a display screen 120 (FIGS. 12 and 14) which may encompass at least a portion of a window of a cab (not shown), thus providing an operator 1502 with a view of an image 112 of the work area 102 that simulates an actual view of the work area 102. The display 110 may also be incorporated into a display helmet 122 or display glasses 124, as depicted in FIGS. 17a and 17b, and as is known in the art.

A position determining system 126 may be used to determine a position of at least one of the work area 102, the work machine 114, and a work tool 128 located on the work machine 114. The position determining system 126 may determine position in site coordinates, e.g., x, y, z coordinates or latitude and longitude, and may be GPS based, laser based, inertial reckoning, or some combination of systems. The position determining system 126 may deliver position related information to the controller 106, for further processing and use, as described below.

An object location system 130 may be used to locate the position of non-visible objects 132, for example underground objects. Typical object location systems 130 might include such technologies as ground penetrating radar (GPR), acoustic, sonar, and the like. The object location system 130 may deliver information relevant to a location of a non-visible object 132 to the controller 106, for further processing and use, as described below.

Transmission and receiving means 134 provide a way to deliver information to and from a remote location 136. For example, video information and images may be transmitted to a remote location 136 and machine commands may be transmitted back to the work machine 114. The transmission and receiving means 134 may be wireless or wired and may employ any type of communications technology available.

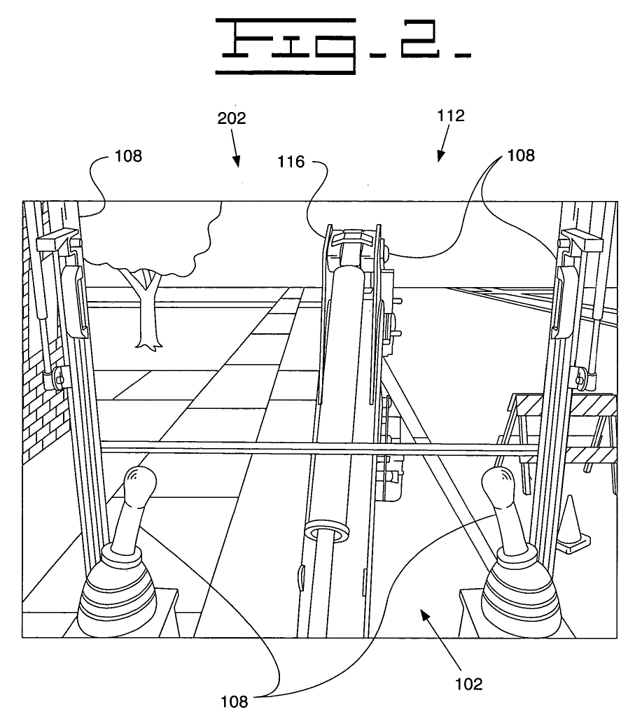

Referring to FIG. 2, an exemplary video image 112 is shown. The image 112 represents a work machine 114 at a work site 102. In the embodiment shown and described throughout, the work machine 114 is depicted as a backhoe loader performing digging operations at the work site 102. However, the work machine 114 may be of a variety of machine types, including, but not limited to, earthworking and construction, mobile and stationary, manufacturing and the like. The work machine 114 may be an actual machine or may be a simulation, such as, for example, training purposes. It is noted that the scope of the present invention is not meant to be limited as to the type of machine or application in which the invention is employed.

The image 112 presented by FIG. 2 may be captured by one camera, i.e., a first image 202, or may be a plurality of images captured by multiple cameras 104 and combined into a superimposed image 206. In the preferred embodiment, two or more cameras 104 capture images which are superimposed into one image 206.

One or more objects 108 are shown in the FIG. 2 image 112. For example, a work implement 116 having a boom and stick are shown. In addition, part of the frame of the work machine cab and joysticks are shown. The objects 108 tend to obstruct the view of the work area 102 from the operator 1502.

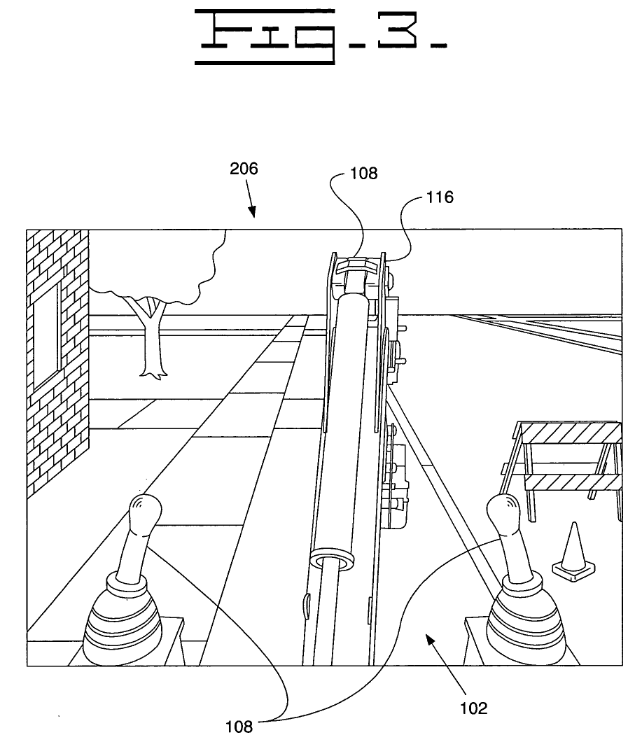

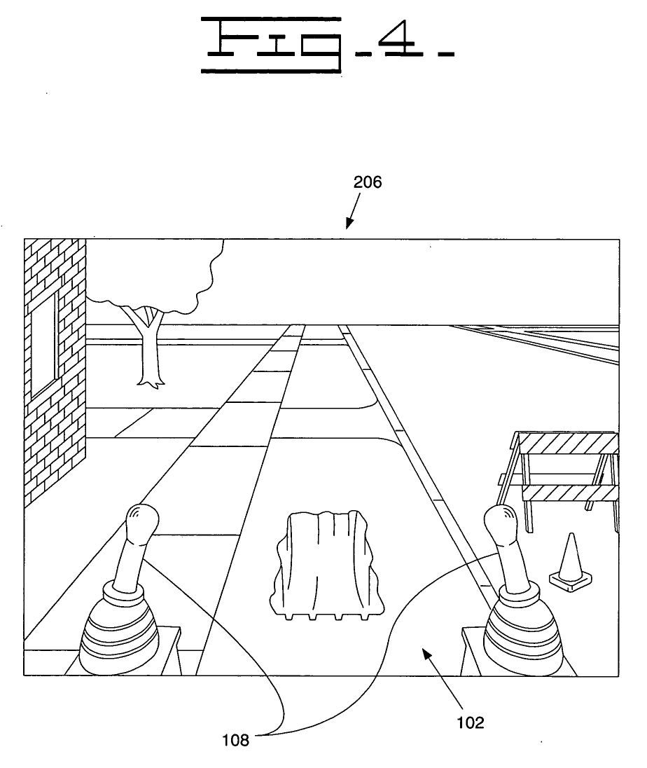

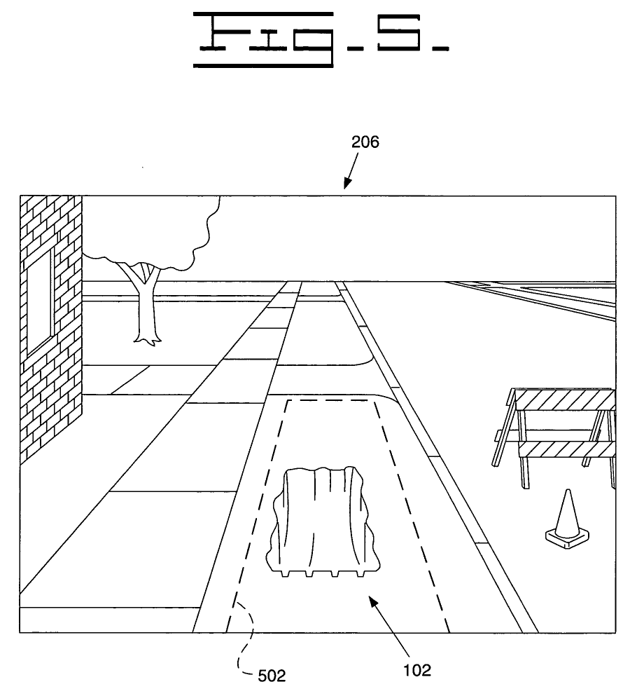

In FIG. 3, one of the objects 108, i.e., the frame of the cab, is removed from the image 112. This may be accomplished by digitally removing the object 108 from each of multiple images, then restoring the area behind the object 108 in the superimposed image 206. The same technique may be used to remove additional objects 108, such as the work implement 116 (FIG. 4), and the joysticks, as shown in FIG. 5. The result is an image 206 having an unobstructed view of the work area 102.

FIG. 5 also indicates a work boundary image 502, which is superimposed on the image 206. The work boundary image 502 may be obtained by determining a work boundary based on data from the position determining system 126. The work boundary image 502 provides the operator 1502 with a guide to assist in performing the desired work, and may be altered as the work progresses.

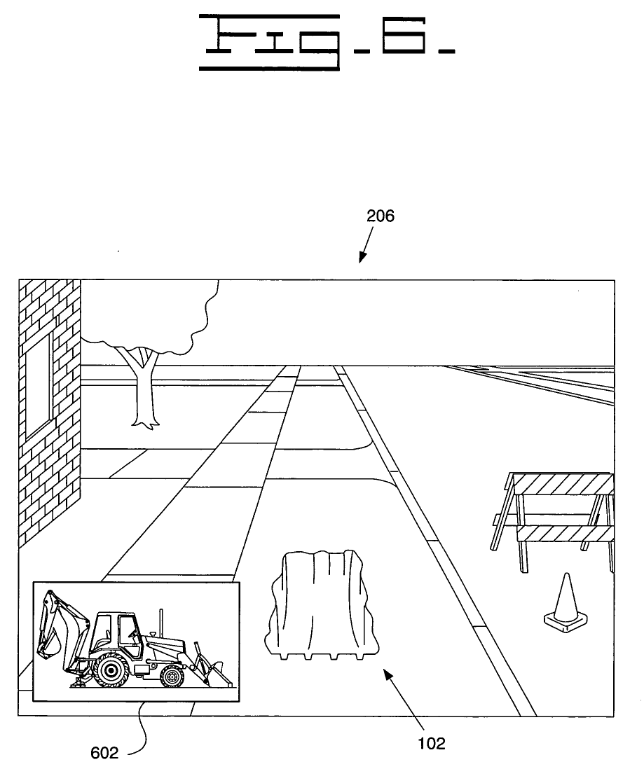

Referring to FIG. 6, a picture-in-picture 602 may be added to the image 206 to provide additional information. The picture-in-picture 602 may, as shown, be another view of the work machine 114. Alternatively, the picture-in-picture may be any other information and may be graphics, text, or any other desired type of display.

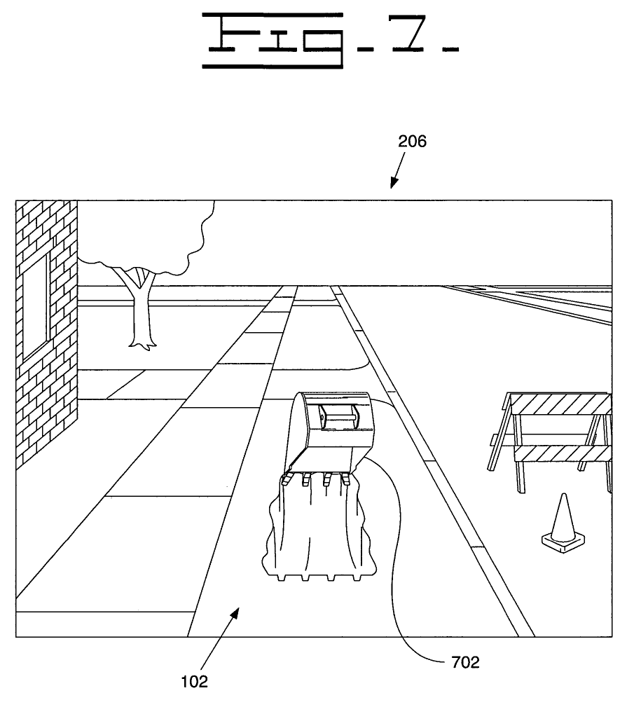

It may be desired to indicate the position of the work tool 128 by determining an actual position of the work tool using position determining techniques which are known in the art, creating a work tool image 702, and providing the work tool image 702 to the display 110 at a position corresponding to the actual work tool position, as shown in FIG. 7. The work tool image 702 may then be moved about to indicate the actual position of the work tool 128, thus allowing the operator 1502 a perceived view of the work tool 128 without any other obstructions.

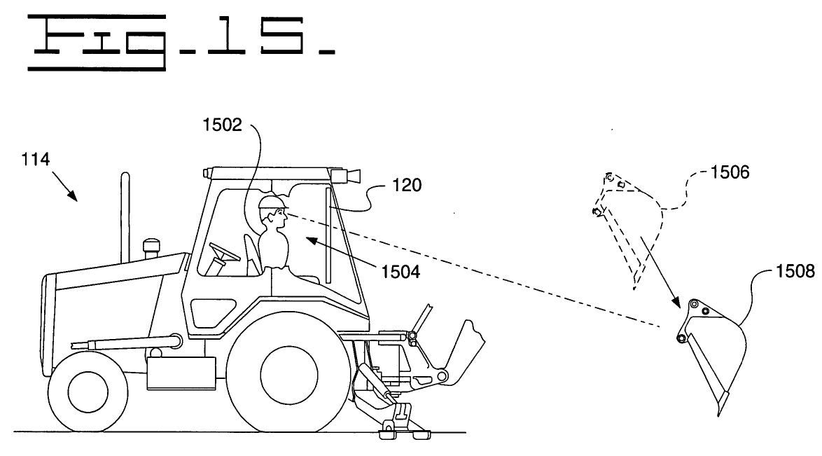

Some amount of calibration may be needed to enable the work tool image 702 to more accurately track the position and movement of the actual work tool 128. For example, referring to FIG. 15, the operator 1502, due to differences in height and exact operator position 1504, may view the work tool image 702 at a position on the display 110 that is not accurate. An exemplary calibration procedure may allow the operator 1502 to place the image 206 in a transparent mode so that both the work tool image 702 and the actual work tool 128 may be seen. The position 1506 of the work tool image 702 may then be adjusted to match the position 1508 of the work tool 128. The image 206 may then be restored to full viewing mode with the work tool image 702 position 1506 being calibrated.

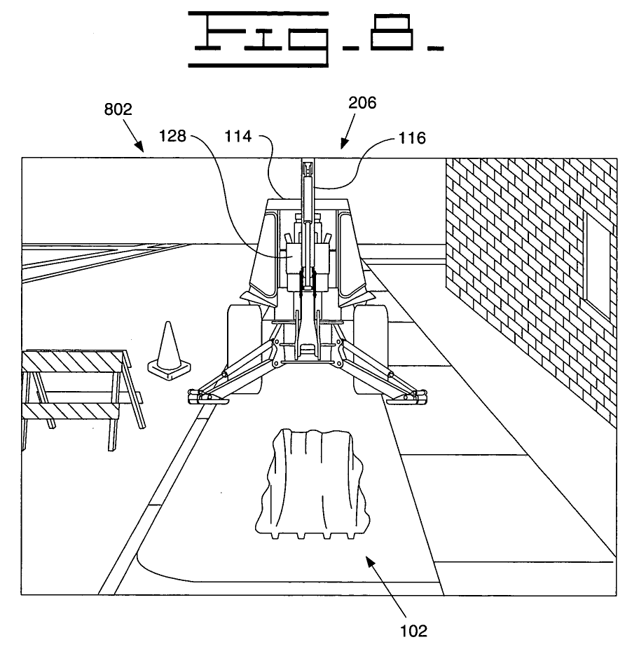

Referring to FIG. 8, a diagrammatic illustration which represents another aspect of the present invention is shown. The location of the work area 102, the work machine 114, and the work tool 128, in site coordinates, is determined. Using this information, a virtual image 802 of a view of at least one of the work area, the work machine 114, and the work tool 128 is provided from at least one position other than the operator position 1504 of the work machine 114. For example, the operator 1502 may then view the work area 102 from a location away from the work machine 114, thus providing a different perspective of the work being performed. The virtual image 802 may be shifted to provide views from other positions as well, using the same techniques. In addition, objects 108 may be removed from the display 110 by the same methods as described above, and the view without the objects 108 may be restored so that it appears that the objects 108 did not exist at all. This aspect allows an operator to view the work area from different angles without leaving the work machine.

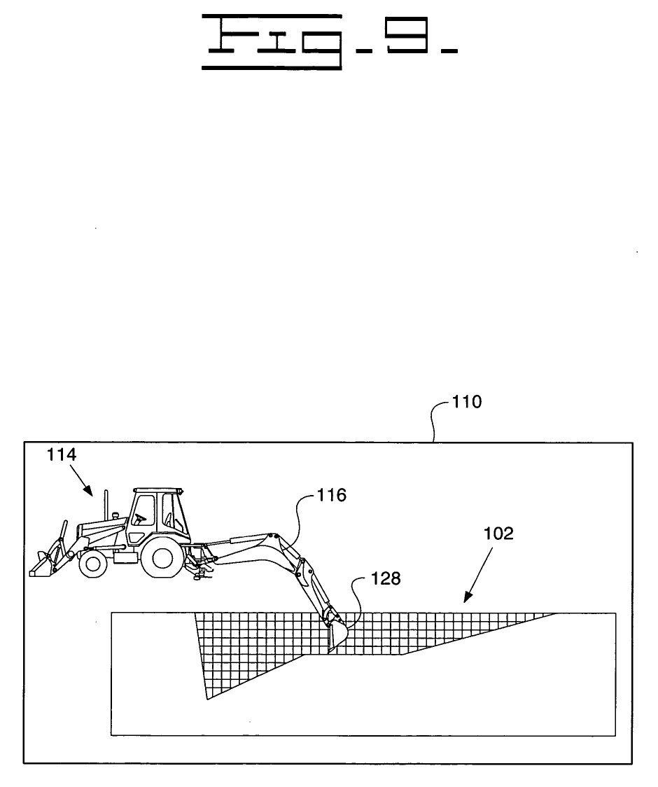

Referring to FIG. 9, a diagrammatic illustration of a view of a work machine 114 at a work area 102 is shown. In this view, the work machine 114 is viewed from the side as a work implement 116 having a work tool 128 engages the work area 102; that is, as the work tool 102 digs in the work area 102. A side profile view of a cross section of the work area 102 allows for monitoring of the extent of digging taking place. The view of FIG. 9 may be used to supplement other views of the work area 102, as described above. For example, the view of FIG. 9 may be inserted as a picture-in-picture 602 in the display 110.

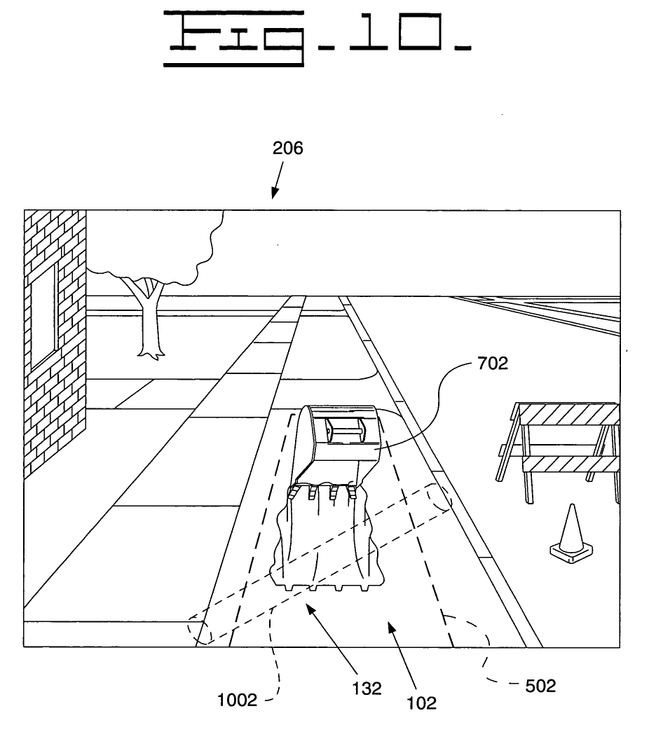

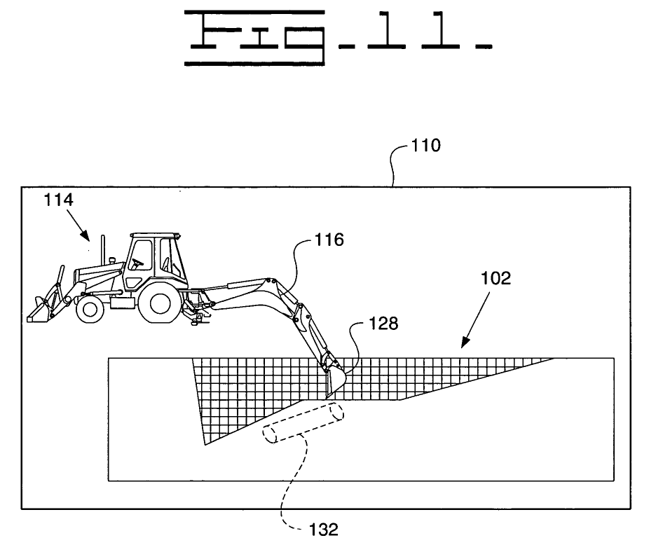

FIG. 10 depicts a view of a superimposed image 206 having a work boundary image 502, a work tool image 702, and an image 1002 of a not-visible object 132. The not-visible object 132 maybe an underground object located in an area being excavated. It is known in the art that underground objects may be located by means such as ground penetrating radar (GPR) and the like. The present invention may locate underground objects using the object location system 130, as described above. After locating the object, it is also known to determine the location of the object with respect to site coordinates. With these tools, an image 1002 of the object 132 maybe superimposed on the image 206 of the work site 102 to allow an operator 1502 to view the location of the object as work is performed. FIG. 11 shows the side view of FIG. 9 with a not-visible object 132 included in the view.

Referring to FIG. 12, the exemplary work machine 114 is shown from above. Included in the figure are video cameras 104 (two) mounted on the work machine 114 at a location suited for capturing a view of the area in which the work implement 116 and work tool 128 are positioned. Assuming that the work machine 114 is positioned for work, this area may correspond to the work area 102. A display screen 120 replaces what would normally be a window of a cab of the work machine 114. The display screen 120 may be transparent when not in use, thus reverting back to a normal window.

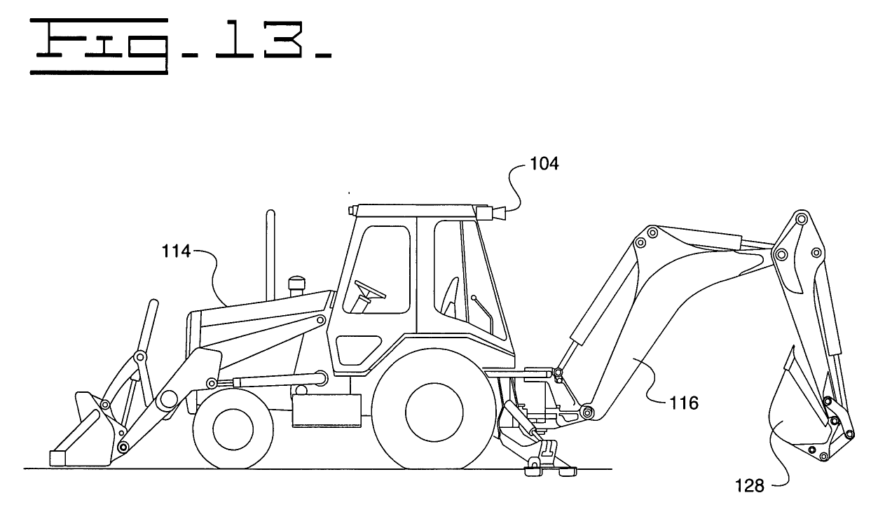

FIG. 13 shows a side view of the work machine 114 having video cameras 104 (one shown) mounted as described above. The work machine 114 is shown as a backhoe. However, other types of work machines may be used, including, but not limited to, earthworking and construction machines, and machines which may be mobile or stationary.

In FIG. 14, the top view of the work machine 114 of FIG. 12 is shown to provide illustration of the video cameras 104 in operation. One of the cameras 104 is configured to cover a first portion 1402 of the work area 102, and the other camera 104 is configured to cover a second portion 1404 of the work area 102. The two portions 1402,1404 are superimposed to provide the superimposed image 206, as described above. The portions 1402,1404 may be determined so that objects 108, such as the work implement 116 and work tool 128 of FIG. 14, may be removed from the superimposed image 206 and the image of the work area 102 without the objects 108 may be restored.

### INDUSTRIAL APPLICABILITY

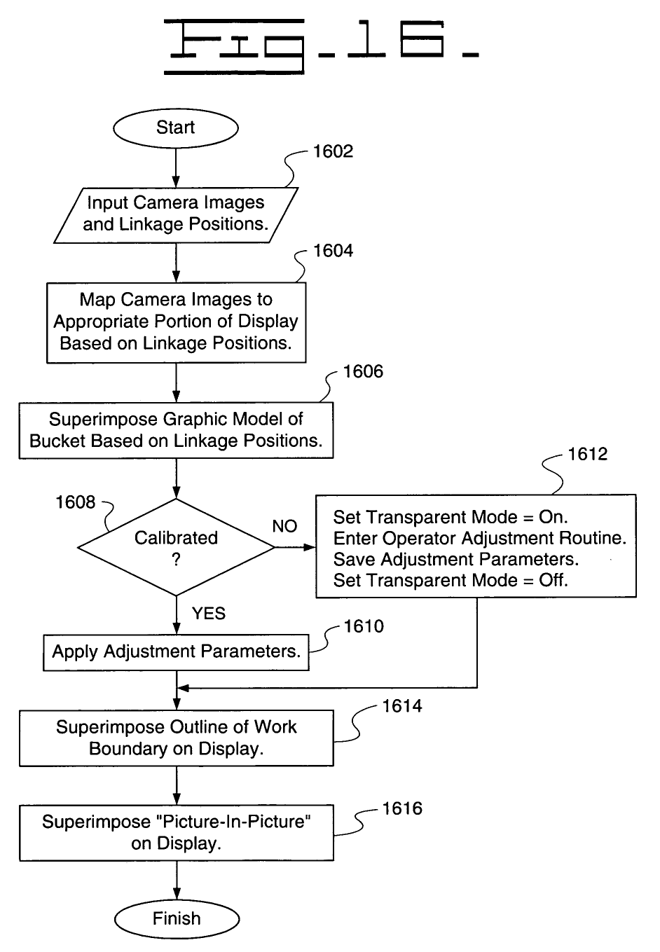

An example of a method of the present invention may be illustrated by reference to the flow diagram of FIG. 16.

In a first input block 1602, information such as camera images 112, linkage positions, and the like are input into the controller 106.

In a first control block 1604, camera images 112 are mapped to appropriate portions of the display 110 based on linkage positions, e.g., the positions of the work implement 116 and work tool 128. The images 112 are superimposed to provide a superimposed image 206.

In a second control block 1606, the actual position of the work tool 128, e.g., bucket, is determined and a work tool image 702 is added to the superimposed image 206. The work tool image 702 moves about in cooperation with movement of the actual work tool 128.

In a first decision block 1608, a decision may be made to calibrate an image position 1506, such as the position of the work tool image 702. As described above, certain conditions, such as differences in operator position 1504, may contribute to the position of the work tool image 702 being offset from the position of the actual work tool 128. The calibration process, as depicted in a third control block 1612, may include setting a transparent mode of the display 110, e.g., a display screen 120, to an “on” position, initiating an operator adjustment routine, for example moving the work tool image 702 via joystick control until the position of the work tool image 702 coincides with the position of the work tool 128, saving the adjusted settings, and setting the transparent mode to an “off” position.

If the decision is made that no calibration is needed, control proceeds to a fourth control block 1610 and the current adjustment parameters for the image position 1506 are used.

In a fifth control block 1614, an outline of a work boundary image 502 is added to the superimposed image 206, as shown in FIG. 5 and described above. Variations of the work boundary image 502 may be used. For example, multiple work boundaries, corresponding to degrees of desired accuracy, may be used. In addition, if certain portions of the work boundary are more critical than others, images other than dashed lines, as shown, may be used. For example, bold solid lines, or flashing lines may be used for critical portions of the boundary.

In a sixth control block 1616, a picture-in-picture 602 image may be superimposed on the display 110, for example as shown in FIG. 6. However, the picture-in-picture 602 may display something other than an image, for example text, warnings, and any other information that might be useful. It is noted that the picture-in-picture 602 need not be located as FIG. 6 depicts, i.e., in the lower right corner, but rather may be located anywhere and at any size.

The flow diagram of FIG. 16 gives examples of possible features that may be incorporated into the present invention and is not meant to be limiting. For example, several other features are described above, and additional features may be used without deviating from the spirit and scope of the invention.

Other aspects can be obtained from a study of the drawings, the disclosure, and the appended claims.

What is claimed is:

1. A method for providing a view of a work area, comprising the steps of:
capturing a first image of a first desired portion of the work area;
removing at least one object from the image; and
providing the first image with the at least one object removed to a display.

2. A method, as set forth in claim 1, further comprising the steps of:
capturing a second image of a second desired portion of the work area;
superimposing the first and second images to remove the at least one object; and
providing the superimposed image to the display.

3. A method, as set forth in claim 1, further including the step of superimposing a work boundary image to the display.

4. A method, as set forth in claim 1, further including the steps of:
determining an actual position of a work tool;
creating an image of the work tool; and
providing the work tool image to the display at a position corresponding to the actual position.

5. A method, as set forth in claim 4, further including the step of moving the image of the work tool as a function of actual movement of the work tool.

6. A method, as set forth in claim 1, further including the steps of:
determining a location of the work area, a work machine in the work area, and a work tool attached to the work machine in site coordinates; and
providing a virtual image of at least one of the work area, the work machine, and the work tool from at least one position other than an operator position of the work machine.

7. A method, as set forth in claim 1, further including the steps of:
determining a position of at least one object not visible in the work area; and
providing an image of the object to the display.

8. A method, as set forth in claim 1, further including the step of delivering the first image to a remote location.

9. A method, as set forth in claim 8, further including the step of enabling remote operation of a machine at the work area as a function of the first image.

10. A method for providing a view of a work area, comprising the steps of:
capturing a plurality of images of a corresponding plurality of portions of the work area;
superimposing the plurality of images such that at least one object is removed from the superimposed image; and
providing the superimposed image to a display.

11. A method for providing a view of a boundary of a work area, comprising the steps of:
capturing at least one image of at least one desired portion of the work area;
providing a superimposed image from the at least one image to a display; and
superimposing a work boundary to the display.

12. A method, as set forth in claim 11, further including the steps of:
removing at least one object from the at least one image; and
providing the superimposed image with the at least one object removed.

13. A method for displaying an image of a work tool at a work area, comprising the steps of:
capturing at least one image of at least one desired portion of the work area;
providing a superimposed image from the at least one image to a display;
determining an actual position of a work tool;
creating an image of the work tool; and
providing the work tool image to the display at a position corresponding to the actual position.

14. A method, as set forth in claim 13, further including the steps of:
removing at least one object from the at least one image; and
providing the superimposed image with the at least one object removed.

15. A method, as set forth in claim 13, further including the step of moving the image of the work tool as a function of actual movement of the work tool.

16. A method, as set forth in claim 13, further including the step of calibrating the location of the image of the work tool to correspond to the actual location of the work tool.

17. A method for providing a view of a work area, comprising the steps of:
determining a location of the work area, a work machine in the work area, and a work tool attached to the work machine in site coordinates; and
providing a virtual image of a view of at least one of the work area, the work machine, and the work tool from at least one position other than an operator position of the work machine.

18. A method, as set forth in claim 17, further including the step of shifting the view to provide a virtual image of a view from a different position.

19. A method, as set forth in claim 17, further including the steps of:
determining an object to be removed from the virtual image;
removing the object from the image; and
modifying the image to restore the view of at least one of the work area, the work machine, and the work tool with the object removed.

20. A method for providing a view of a work area, comprising the steps of:
capturing at least one image of at least one desired portion of the work area;
providing a superimposed image from the at least one image to a display;
determining a position of at least one object not visible in the work area; and
superimposing an image of the object to the display.

21. An apparatus for providing a view of a work area, comprising:
at least one video camera located at a desired position with respect to the work area;
a controller for receiving video signals from the at least one camera, superimposing the signals, determining at least one object to remove from view, and providing a resultant video signal; and
a display for receiving the resultant video signal and displaying an image of a view of the work area with the at least one object removed.

22. An apparatus, as set forth in claim 21, wherein the at least one camera is located on a work machine.

23. An apparatus, as set forth in claim 22, wherein the at least one object to remove from view includes at least one of a portion of a work implement and a portion of the work machine.

24. An apparatus, as set forth in claim 21, wherein the display is a display monitor.

25. An apparatus, as set forth in claim 22, wherein the display is a display screen replacing an actual view with the image view to an operator of the work machine.

26. An apparatus, as set forth in claim 22, wherein the display is one of a display helmet and display glasses worn by an operator of the work machine.

27. An apparatus, as set forth in claim 22, further including a position determining system for determining a position of at least one of the work area, the work machine, and a work tool located on the work machine.

28. An apparatus, as set forth in claim 22, further including an object location system for determining a location of an object hidden from view.

29. An apparatus, as set forth in claim 21, further including transmission and receiving means for delivering at least one of the video signal, resultant video signal and image to a remote location.
